(19) United States
(12) Patent Application Publication
(10) Pub. No.: US 2015/0205442 A1
(43) Pub. Date: Jul. 23, 2015

(54) OPTICAL TOUCH SCREEN

(71) Applicant: QUANTA COMPUTER INC., Taoyuan Shien (TW)

(72) Inventors: Chien-Hung LIN, Taoyuan County (TW); Yun-Cheng LIU, Taipei County (TW)

(73) Assignee: QUANTA COMPUTER INC., Taoyuan Shien (TW)

(21) Appl. No.: 14/445,694

(22) Filed: Jul. 29, 2014

(30) Foreign Application Priority Data
Jan. 22, 2014 (TW) 103102324

(51) Int. Cl. G06F 3/042

(52) U.S. Cl. CPC G06F 3/0421; G06F 3/0425

(57) ABSTRACT

The present invention provides an optical touch screen including a transparent panel, a camera module and at least one retro-reflector. The transparent panel includes a bottom surface and a touch surface opposite to each other, a corner and sides. The camera module disposed on the corner includes a light source, a light guide component, an optical clear adhesive and an optical sensor. The light source is used for emitting an incident light, in which a vertical distance between the light source and the touch surface is greater than a vertical distance between the bottom surface and the touch surface. The optical clear adhesive is used to fix the light guide component on the transparent panel, and the incident light enters the transparent panel through the light guide component and the optical clear adhesive with total reflection between the bottom surface and the touch surface.

### RELATED APPLICATIONS

This application claims priority to Taiwan Application Serial Number 103102324, filed Jan. 22, 2014, which is herein incorporated by reference.

### BACKGROUND

1. Field of Invention

The present invention relates to a touch screen. More particularly, the present invention relates to an optical touch screen.

2. Description of Related Art

Touch technology refers to a combination of display and input modules of an electronic device. A user can control the electronic device simply by pressing or touching the display. The touch screen is normally categorized into three types, resistive type, capacitive type, and optical type. For the optical touch screen, because there are no traces used for sensing being disposed between the glass and the panel, this type of the touch screen may have a cost advantage when utilized as a large-size touch screen.

The light sources and the receivers of the optical touch screen are disposed on the edges or the corners of the screen. These light sources emit light, which in this case is invisible, such as an infrared ray, above the screen. When a user touches the screen, an infrared ray with a specified direction is blocked, in such a way that the receiver would not receive the blocked infrared ray in the specified direction. Therefore, the position where the screen is touched can be located after calculation.

The sensitivity of an optical touch screen is affected by the density of light (such as an infrared ray net) above the screen. A method for enhancing the density of light distribution therefore becomes an important issue.

### SUMMARY

An embodiment of this invention provides a module design for an optical touch screen including a light guide component for adjusting an incident light angle such that the amount of effective light entering a transparent panel and the density of light in the transparent panel is increased, and enhancement of the sensitivity of the optical touch screen is achieved as an additional benefit.

The present invention provides an optical touch screen including a transparent panel, a camera module and at least one retro-reflector. The transparent panel includes a bottom surface and a touch surface opposite to each other, a corner and sides. The camera module disposed on the corner includes a light source, a light guide component, an optical clear adhesive and an optical sensor. The light source is used for emitting an incident light, in which a vertical distance between the light source and the touch surface is greater than a vertical distance between the bottom surface and the touch surface. An optical clear adhesive is used to fix the light guide component on the transparent panel, and the incident light enters the transparent panel through the light guide component and the optical clear adhesive with total reflection occurring between the bottom surface and the touch surface. The optical sensor is used for receiving a light signal. The retro-reflectors are used for reflecting the incident light such that the incident light travels in a direction reversed from the original, and then the optical sensor captures the incident light.

### BRIEF DESCRIPTION OF THE DRAWINGS

The invention can be more fully understood by reading the following detailed description of the embodiment, with reference made to the accompanying drawings as follows:

FIG. 1A is a bottom view of an optical touch screen according to the first embodiment of the present invention;

FIG. 1B is a cross-sectional view in FIG. 1A taken along line A-A′;

FIG. 2A is a schematic diagram of a light guide component in FIG. 1B according to an embodiment of the present invention;

FIG. 2B is a schematic diagram of a light guide component in FIG. 1B according to another embodiment of the present invention;

FIG. 3 is a cross-sectional view of the optical touch screen of FIG. 1B when the optical touch screen is touched by a finger;

FIG. 4 is a bottom view of an optical touch screen according to a first embodiment of the present invention;

FIG. 5A is an image formed by the sensor when there is no object on the transparent panel according to the first embodiment of the present invention;

FIG. 5B is an image formed by the sensor when there is an object on the transparent panel according to the first embodiment of the present invention;

FIG. 6 is a bottom view of the optical touch screen when there is an object on the transparent panel according to the first embodiment of the present invention;

FIG. 7A is a bottom view of an optical touch screen according to a second embodiment of the present invention;

FIG. 7B is a cross-sectional view in FIG. 7A taken along line B-B′;

FIG. 8A is a bottom view of an optical touch screen according to a third embodiment of the present invention;

FIG. 8B is a cross-sectional view in FIG. 8A taken along line C-C′;

FIG. 9A is a bottom view of an optical touch screen according to a fourth embodiment of the present invention;

FIG. 9B is a cross-sectional view in FIG. 9A taken along line D-D′;

FIG. 10A is a bottom view of an optical touch screen according to a fifth embodiment of the present invention;

FIG. 10B is a cross-sectional view in FIG. 10A taken along line E-E′;

FIG. 11A is a bottom view of an optical touch screen according to a sixth embodiment of the present invention; and

FIG. 11B is a cross-sectional view in FIG. 11A taken along line F-F′.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The optical touch device is an apparatus taking a light signal as a detective source, the sensitivity of the apparatus is affected by a density of light (such as infrared ray net) above the screen in the apparatus. In the optical touch device of the present invention, light travels forward in the transparent panel with total reflection. When a user touches the transparent panel, the total reflection may be destroyed, and the intensity of light in the transparent panel may decrease. Therefore, the intensity of light signal from a specific direction received by the sensor may be weakened, so that the position where the panel is touched can be known. The optical touch device of the present invention further includes a light guide component to increase the numbers of effective light and the density of light in the transparent panel, such that the sensitivity of the optical touch screen is raised.

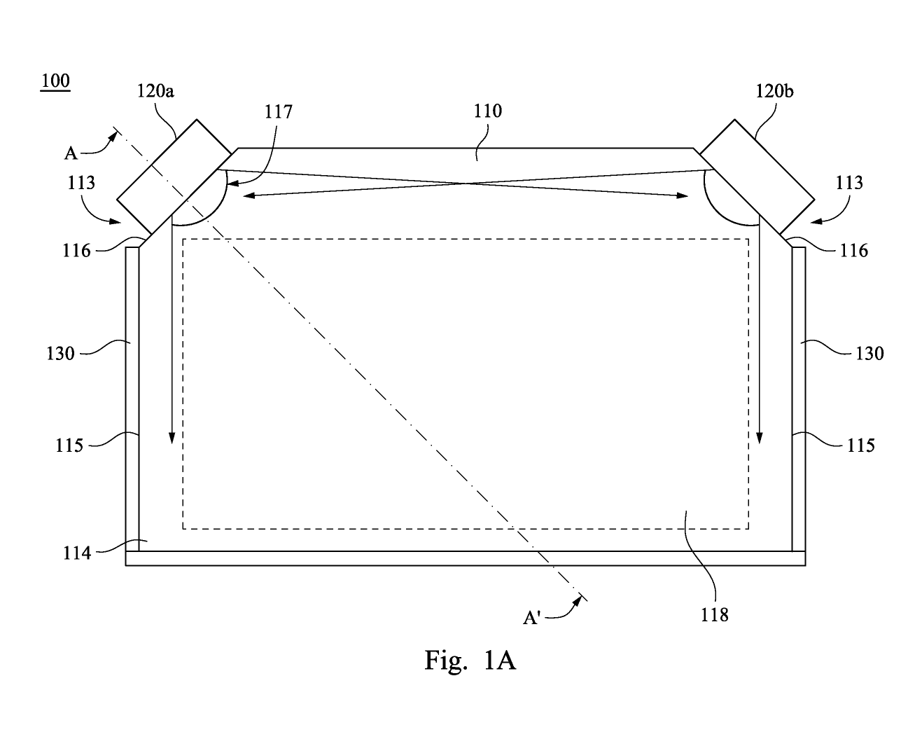

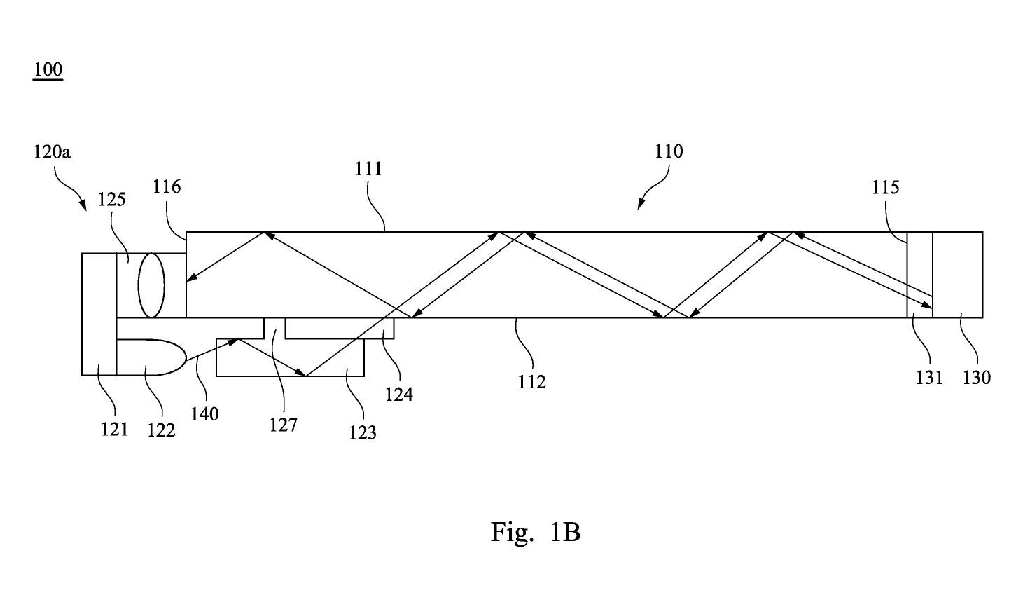

FIG. 1A is a bottom view of an optical touch screen according to a first embodiment of the present invention. FIG. 1B is a cross-sectional view in FIG. 1A taken along line A-A′. An optical touch screen 100 includes a transparent panel 110, camera modules 120a and 120b, and at least one retro-reflector 130.

The transparent panel 110 includes a bottom surface 111 and a touch surface 112 opposite to each other, a pair of bevel corners 113, a pair of right angle corners 114 and sides 115. The bevel corners 113 are located at two adjacent corners of the transparent panel 110. The right angle corners 114 are located at another two adjacent corners of the transparent panel 110. The bevel corners 113 include bevel structure such that providing guide surfaces 116 to connect the two adjacent sides 115. According to an embodiment of the present invention, an angle between the guide surface 116 and the side 115 is 45 degrees, and the sides 115 are orthogonal at the right angle corners 114.

The camera modules 120a and 120b are substantially the same modules, in the present embodiment, the description is taking the camera module 120a as an example, and structure and function of the camera module 120b are similar to the camera module 120a. Hence, the relate description about camera module 120b is not described in the present embodiment. The camera module 120a is disposed on the bevel corner 113, in which the camera module 120a includes a light source 122, a light guide component 123, a first optical clear adhesive (OCA) 124 and an optical sensor 125.

The light source 122 is used for emitting an incident light 140, in which a vertical distance between the light source 122 and the touch surface 111 is greater than a vertical distance between the bottom surface 112 and the touch surface 111 such that the incident light 140 emitted by the light source 122 enters into the transparent panel 110 with a greater angle. For making the description succinct, only one of the incident lights 140 is illustrated in the figures and the description.

The light guide component 123 is used for guiding the incident light 140 emitted by the light source 122 and fixed on the bottom surface 112 through the first optical clear adhesive 124. In an embodiment, the refractive index of the light guide component 123, the first optical clear adhesive 124 and the transparent panel 110 are approximately the same. Therefore, when light travels through the above different mediums, energy loss as a result of the refraction and the reflection can be mitigated, such that the inaccuracy caused by the medium changing is reduced. The light guide component 123 includes a protrusion 127 protruding toward the bottom surface 112, and a gap between the light guide component 123 and the bottom surface 112 is partially filled with the first optical clear adhesive 124. After the incident light 140 guided by the light guide component 123 travels via the first optical clear adhesive 124, the incident light 140 enters into the transparent panel 110.

For a more specific description, the light guide component 123 is disposed at a side of the light source 122. A gap between the fore portion of the light guide component 123 and the bottom surface 112 is an air-gap, and other gap between the back portion of the light guide component 123 and the bottom surface 112 is filled by the first optical clear adhesive 124. The protrusion 127 protruding toward the bottom surface 112 is located between the fore portion of the light guide component 123 and the back portion of the light guide component 123. When the incident light 140 travels in the fore portion of the light guide component 123, the incident light 140 travels forward with total reflection. After traveling in the back portion of the light guide component 123, the incident light 140 first enters an area with the first optical clear adhesive 124 and then enters into the transparent panel 110 with in a way of total reflection between the touch surface 111 and the bottom surface 112.

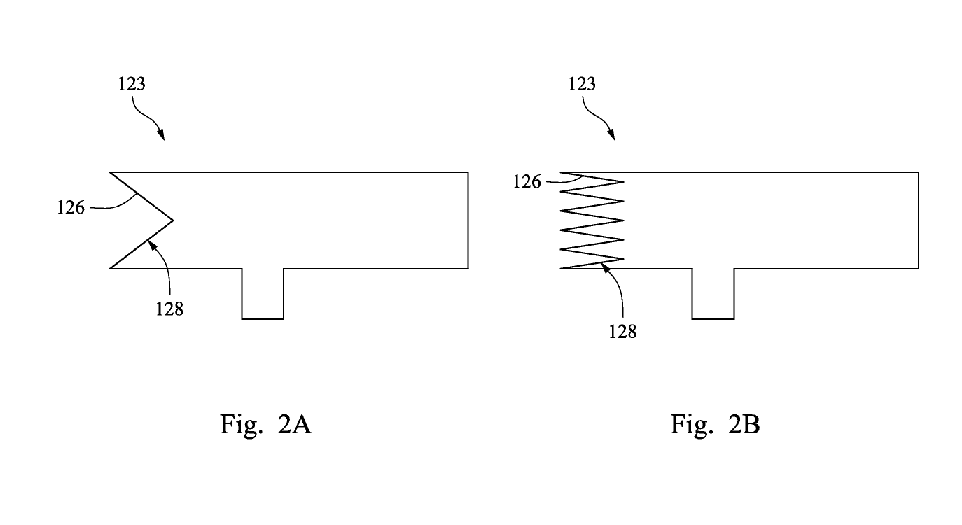

FIG. 2A is a schematic diagram of a light guide component in FIG. 1B according to an embodiment of the present invention. FIG. 2B is a schematic diagram of a light guide component in FIG. 1B according to another embodiment of the present invention. The light guide component 123 includes an incident surface 126 with at least one V-shape groove 128. As mentioned above, the light guide component 123 is used for guiding the incident light 140 emitted by the light source 122 (as shown in FIG. 1B) to let an incident angle of light entering into the incident surface 126 increased, and therefore the destiny of light in the transparent panel 110 is raised with the numbers of the effective light is increased. However, people having ordinary skill in the art can make proper modification to shape, depth, number of the V-shape grooves 128 according to their actual needs. The incident surface 126 of the light guide component 123 may be a plane, a V-shape groove 128 or a plurality of V-shape grooves 128, and shape of the incident surface 126 is not stated again in the following embodiments.

Referring back to FIG. 1A and FIG. 1B, the retro-reflectors 130 are disposed on the sides 115 of the transparent panel 110 to reflect the incident light 140 and adhered via a second optical clear adhesive 131. The optical sensor 125 is used for receiving the incident light 140 reflected by the retro-reflectors 130.

The optical sensor 125 is disposed corresponding to the guide surfaces 116, and both the light source 122 and the optical sensor 125 are disposed on a substrate 121. The substrate 121 can be a flexible printed circuit (FPC), and the light source 122 and the optical sensor 125 can be set by properly arranging the substrate 121.

The incident angle of the incident light 140 of the light source 122 can be adjusted by the light guide component 123, such that the incident light 140 enters into the transparent panel 110 with a greater angle, and therefore a number total reflection times of the incident light 140 between the touch surface 111 and the bottom surface 112 is increased. The incident light 140 travels forward in the transparent panel 110 with the way of total reflection between the touch surface 111 and the bottom surface 112 until the incident light 140 reaches the retro-reflectors 130. After the incident light 140 is reflected by the retro-reflectors 130, the incident light 140 goes in a direction reversed to the original, and then the optical sensor 125 captures the incident light 140. Due to that the incident light 140 is totally reflected between the touch surface 111 and the bottom surface 112, there is almost no decrease in intensity of the incident light 140.

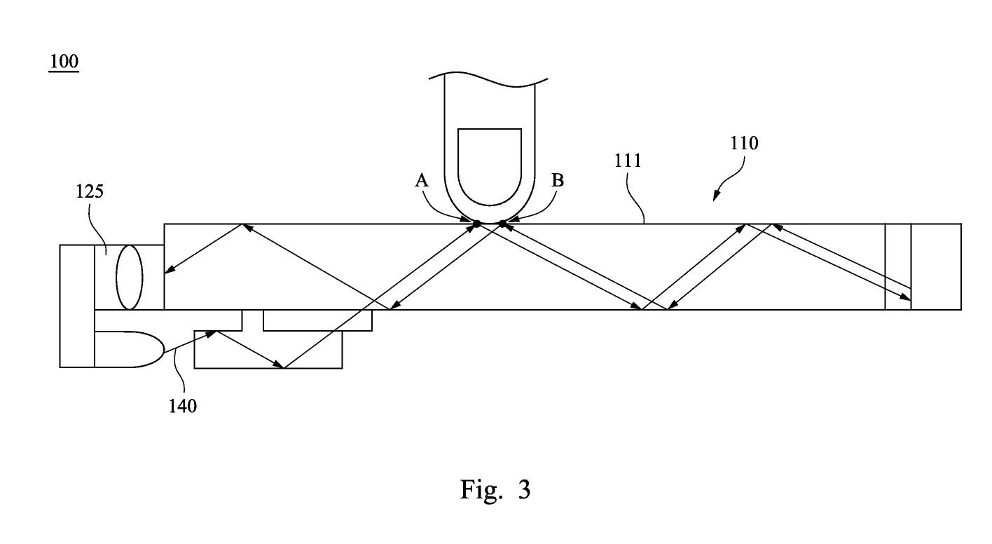

FIG. 3 is a cross-sectional view of the optical touch screen of FIG. 1B when the optical touch screen is touched by a finger. When the touch surface 111 is touched by the user, the interface characteristics of the touched area of the touch surface 111 may be changed. Therefore, a part of the incident light 140 may be scattered on the area between A and B of the transparent panel 110, and two times the energy loss of the incident light 140 may happen in due to the forward direction and the backward direction. As a result, the optical sensor 125 receives a signal (the reflected incident light 140) with lower intensity such that the position where the transparent panel 110 is touched could be determined.

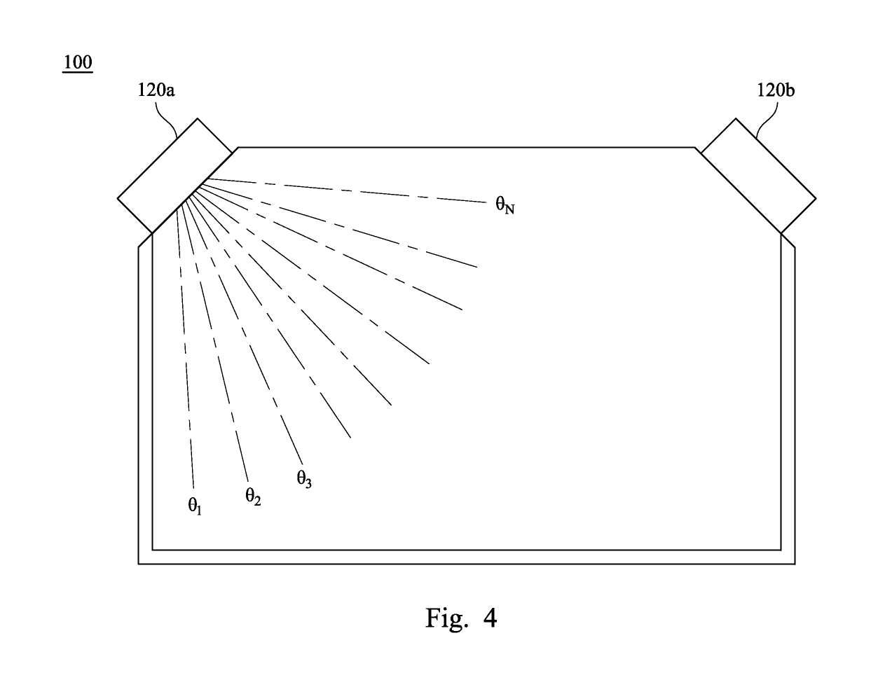

FIG. 4 is a bottom view of an optical touch screen according to a first embodiment of the present invention. As shown in FIG. 1 and FIG. 4, the transparent panel 110 can be a rectangular sheet, and the camera modules 120a and 120b are respectively disposed on the bevel corners 113. The camera modules 120a and 120b can simultaneously emit light in large range of directions in a detection area 117, and the optical sensor 125 (as shown in FIG. 1B) of the camera modules 120a and 120b can be used for receiving the reflected light signals in the detection area 117. For example, the camera module 120a can simultaneously emit and receive light in directions θ₁, θ₂, θ₃, . . . , θ_{N}. Calibration of the relative angles of the optical sensor 125 may be made at the beginning of the operation of the touch screen.

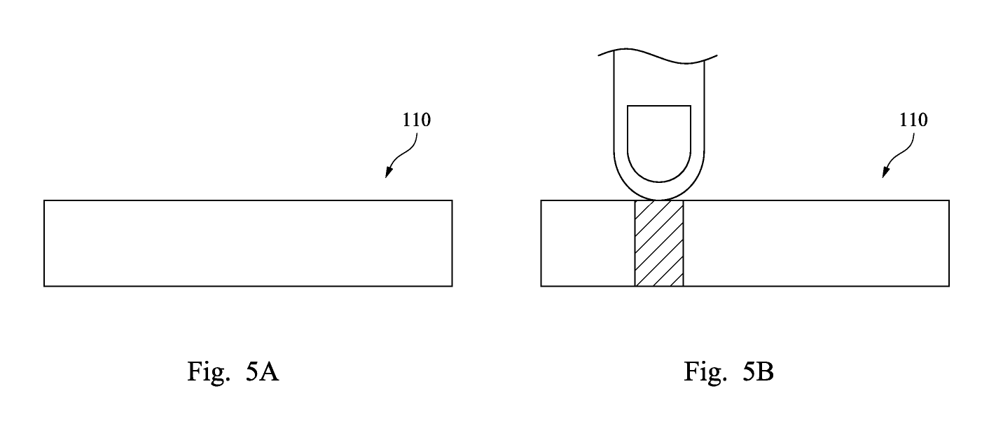

FIG. 5A is an image formed by the optical sensor when there is no object on the transparent panel according to the first embodiment of the present invention. The object can be a user's finger. As shown in FIG. 1B and FIG. 5A, the incident light 140 emitted by the light source 122 travels forward in the transparent panel 110, and the incident light 140 is received by the optical sensor 125 after the incident light 140 is reflected by the retro-reflectors 130. Therefore, the light signal detected by the optical sensor 125 corresponds to the incident light 140 emitted in the same direction, and a corresponding image signal is formed in a specific area of the whole image formed by the optical sensor 125. When there is no object on the transparent panel 110, an image of FIG. 5A is formed, that is, the whole image is white, for almost no energy loss of incident light 140 in all directions.

FIG. 5B is an image formed by the sensor when there is an object on the transparent panel according to the first embodiment of the present invention. As shown in FIG. 3 and FIG. 5B, when the touch surface 111 is touched with a specific direction such as θ₃ (as shown in FIG. 4), the incident light 140 along the direction θ₃ would lose some energy. Then an image signal in an area corresponding to the incident light 140 along the direction θ₃ of the whole image appears relatively dark, and an image of FIG. 5B is formed.

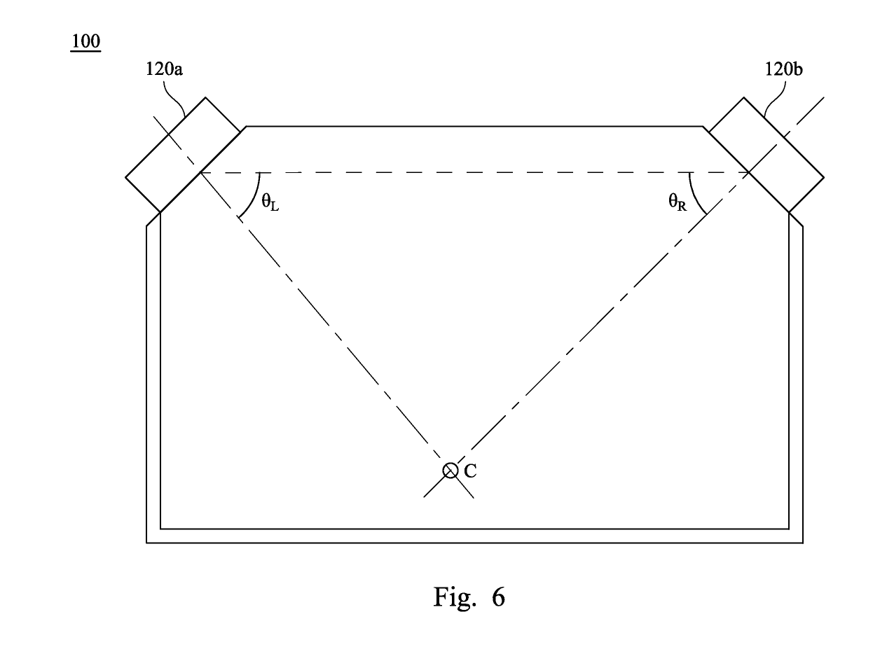

FIG. 6 is a bottom view of the optical touch screen when there is an object on the transparent panel according to the first embodiment of the present invention. As shown in FIG. 6, when the operator touches a point C on the touch surface 111 (as shown in FIG. 1B), by the aforementioned methods, the angle θ_{L} and θ_{R} could be obtained. The angles θ_{L} and θ_{R} are defined by the lines interconnecting the camera module 120a and point C, and the camera module 120b and point C, respectively. At this time, by trigonometry calculation or simultaneous point-slope equations combined with the given coordinates of the camera modules 120a and 120b, the coordinates of the point C can be obtained, so as to achieve detection.

As shown in FIG. 1A, by adjusting the directions of the camera modules 120a and 120b, the detection areas 117 of the camera modules 120a and 120b can define a suitable workspace 118. The workspace 118 can include a screen display area, and the camera modules 120a and 120b can detect the touch position of the finger in the workspace 118.

According to the present embodiment, the incident surface of the light guide component includes the V-shape grooves and the vertical distance between the light source and the bottom surface is greater than the vertical distance between the touch surface and the bottom surface, the incident light enters into the transparent panel with the greater angle. Hence, the number of total reflection times of the incident light traveling forward in the transparent panel is increased. The detection principle of the optical touch screen of the present invention is related to the total reflection, in other words, as the number of the total reflection times is increased, the energy loss of the incident light 140 is reduced and the distance that the incident light 140 could reach or travel is longer. Therefore, the detectable area is increased such that the optical touch screen of the present invention can be applied in the screen with a greater scale, also, the sensitivity of the optical touch screen is improved thereby the inaccurate detection of the optical touch screen due to energy loss would not occur.

The material of the transparent panel 110 can be glass, low-iron glass, or poly(methyl methacrylate) (PMMA). People having ordinal skill in the art can make a proper modification to the material of the transparent panel 110 according to their actual needs.

The light source 122 can be an infrared light-emitting diode (IR LED). People having ordinal skill in the art can make proper modification to the light source 122 according to their actual needs.

The principle of the optical touch screen of the present invention how to detect the locations touched by the users is described as the foregoing embodiments. In the following embodiments, the descriptions are made to discuss the variations of the camera modules 120a and 120b and the retro-reflectors 130.

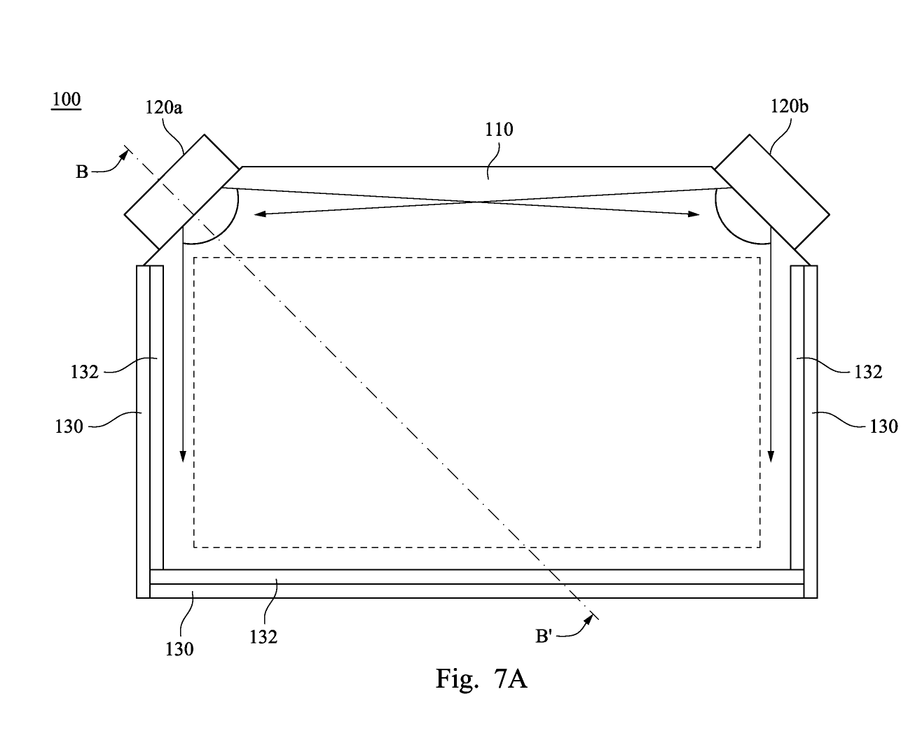

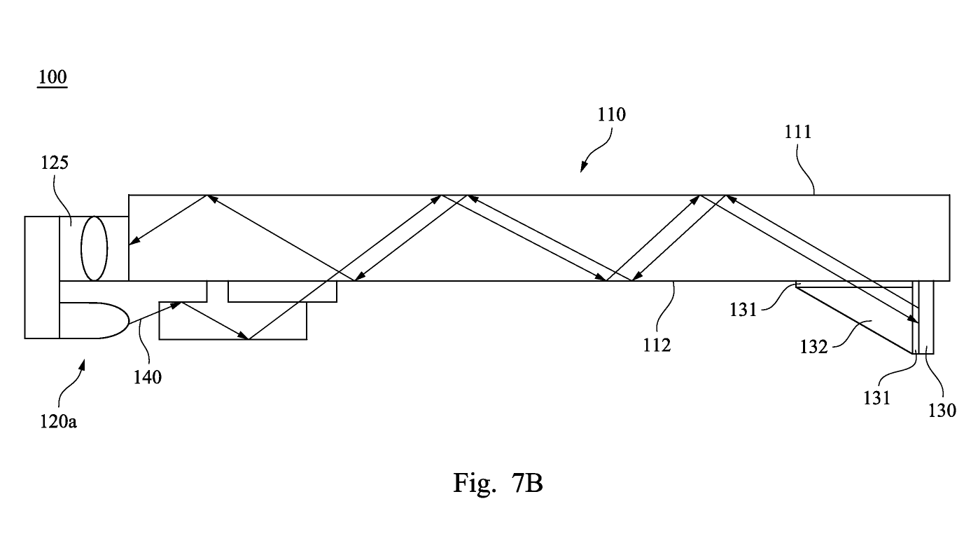

FIG. 7A is a bottom view of an optical touch screen according to a second embodiment of the present invention. FIG. 7B is a cross-sectional view in FIG. 7A taken along line B-B′. An optical touch screen 100 includes a transparent panel 110, camera modules 120a and 120b, and at least one retro-reflector 130, in which the arrangement and the function of transparent panel 110 and camera modules 120a and 120b are the same as the first embodiment.

In the present embodiment, the retro-reflectors 130 stand on a bottom surface 112 of the transparent panel 110, and the optical touch screen 100 further includes a triangular prism 132 for guiding an incident light 140 to the retro-reflectors 130. Two sides of the triangular prism 132 are connected to the retro-reflectors 130 and the bottom surface 112 via a second optical clear adhesive 131 respectively. According to an embodiment of the present invention, the refractive index of the triangular prism 132, the second optical clear adhesive 131 and the transparent panel 110 are approximately the same, such that an optical error caused by the medium characteristic changing and a possibility of the reflection and the refraction occurring at medium interface of the light can be prevented. Furthermore, a vertical distance between the retro-reflectors 130 and a touch surface 111 is greater than a vertical distance between the bottom surface 112 and the touch surface 111.

After the incident light 140 enters into the transparent panel 110, the incident light 140 travels forward in the way of total reflection between the touch surface 111 and the bottom surface 112. Then, after the incident light 140 enters into the triangular prism 132, the incident light 140 is guided to the retro-reflectors 130 via the second optical clear adhesive 131, and the incident light 140 goes in the reversed original path and is received by an optical sensor 125.

In the present embodiment, the retro-reflectors 130 are disposed at different position with the first embodiment, and therefore a thickness of the transparent panel 110 of the present embodiment is thinner than the first embodiment.

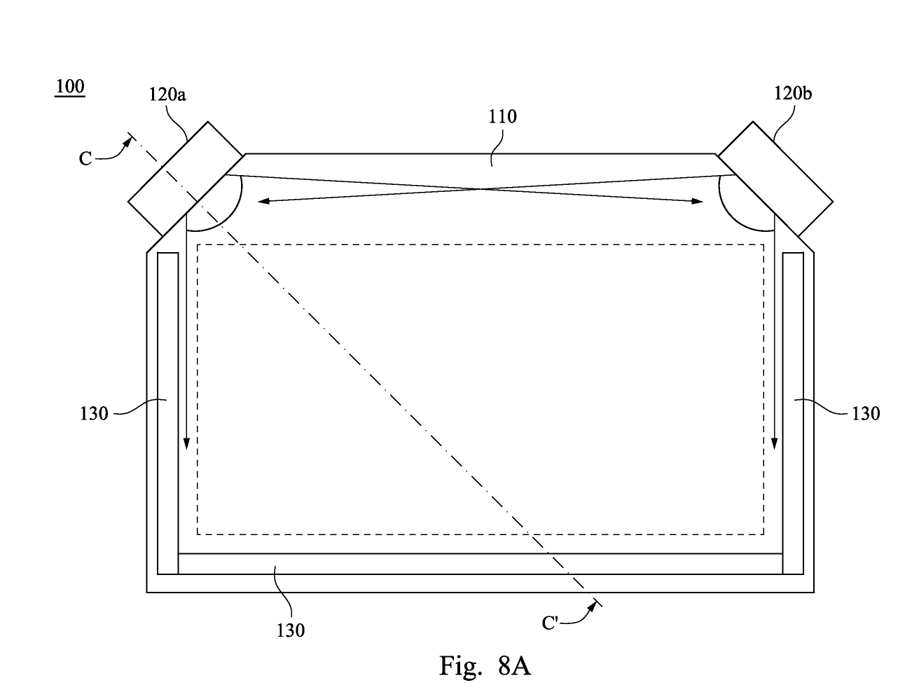

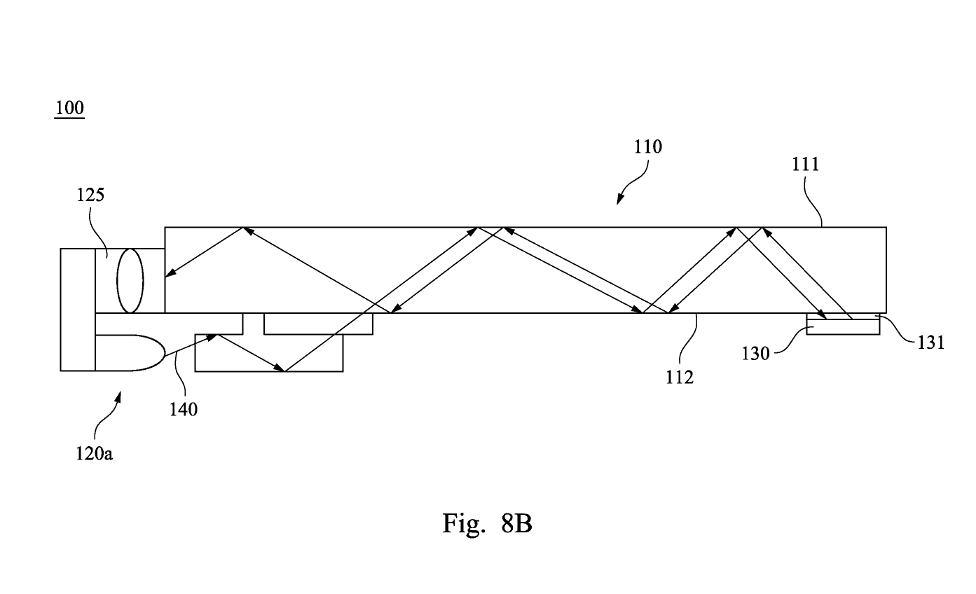

FIG. 8A is a bottom view of an optical touch screen according to a third embodiment of the present invention. FIG. 8B is a cross-sectional view in FIG. 8A taken along line C-C′. An optical touch screen 100 includes a transparent panel 110, camera modules 120a and 120b, and at least one retro-reflector 130, in which the arrangement and the function of transparent panel 110 and camera modules 120a and 120b are the same as the first embodiment.

The retro-reflectors 130 for reflecting an incident light 140 are disposed and laid on a bottom surface 112 of the transparent panel 110 by a second optical clear adhesive 131.

After the incident light 140 enters into the transparent panel 110, the incident light 140 travels forward in the direction of total reflection between a touch surface 111 and the bottom surface 112. Then, incident light 140 is reflected by the retro-reflectors 130 through the second optical clear adhesive 131 such that the incident light 140 goes in the reversed original path, and then an optical sensor 125 captures the incident light 140.

In the present embodiment, through an arrangement that the retro-reflectors 130 are laid on the bottom surface 112, a thickness of the transparent panel 110 is reduced further. Moreover, since the arrangement that the retro-reflectors 130 are laid on the bottom surface 112 is different with the standing arrangement of the second embodiment, a thickness and a volume of the optical touch screen 100 become thinner and smaller.

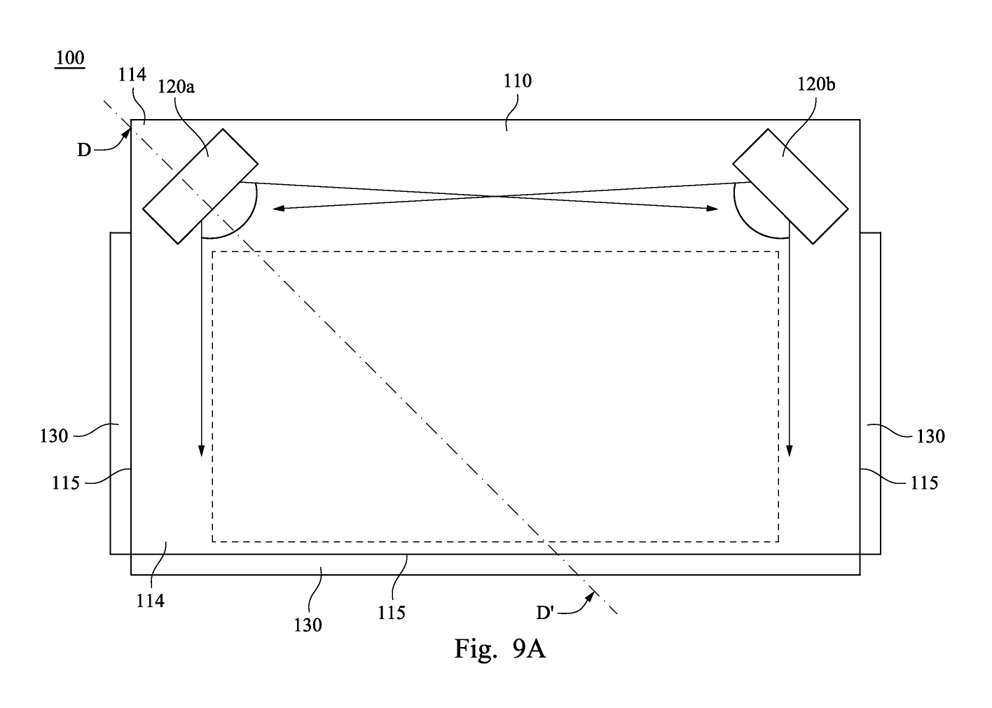

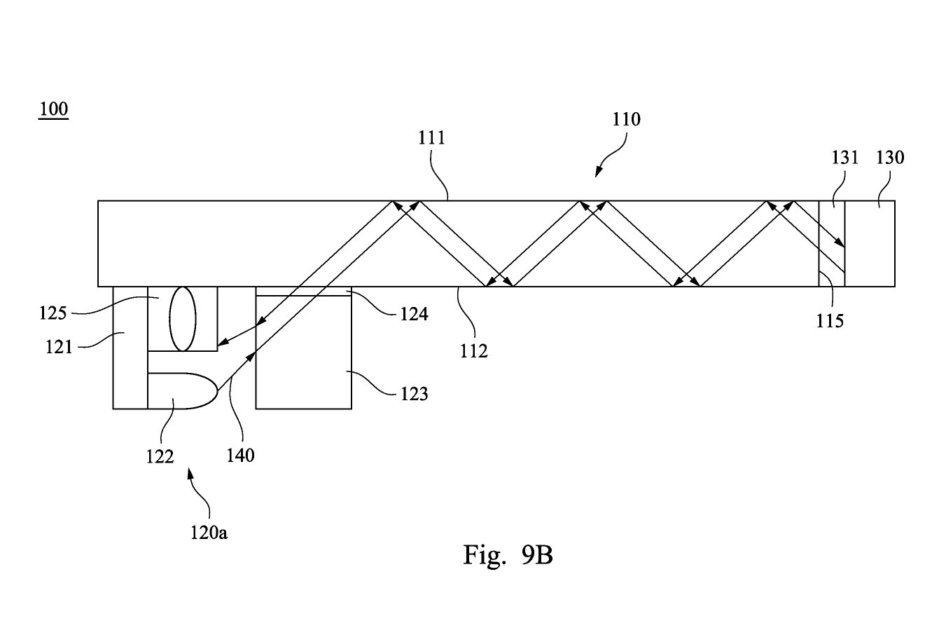

FIG. 9A is a bottom view of an optical touch screen according to a fourth embodiment of the present invention. FIG. 9B is a cross-sectional view in FIG. 9A taken along line D-D′. An optical touch screen 100 includes a transparent panel 110, camera modules 120a and 120b, and at least one retro-reflector 130.

The transparent panel 110 includes a bottom surface 111, a touch surface 112, right angle corners 114 and sides 115, in which the two adjacent sides 115 defining the right angle corner 114.

The camera modules 120a and 120b are the same modules, in the present embodiment, the description is taking the camera module 120a as an example, and structure and function of the camera module 120b is similar to the camera module 120a. The relate description about camera modules 120b is not described in the present embodiment. The camera module 120a is disposed at the right angle corners 114 and on the bottom surface 111. Namely, a vertical distance between the camera module 120a and the touch surface 111 is greater than a vertical distance between the bottom surface 112 and the touch surface 111. The camera module 120a includes a light source 122, a light guide component 123, a first optical clear adhesive 124 and an optical sensor 125.

The light source 122 is used for emitting an incident light 140. The light guide component 123 is used for guiding the incident light 140 emitted by the light source 122 and fixed on the bottom surface 112 through the first optical clear adhesive 124. According to an embodiment of the present invention, a refractive index of the light guide component 123, the first optical clear adhesive 124 and the transparent panel 110 are approximately the same. Therefore, when light travels through above different mediums, energy loss caused by the refraction or the reflection can be mitigated.

The surface of the light guide component 123 facing to the bottom surface 112 is a flat surface. A gap between the light guide component 123 and the bottom surface 112 is totally filled by the first optical clear adhesive 124. After the incident light 140 is guided by the light guide component 123, the incident light 140 enters into the transparent panel 110 through the first optical clear adhesive 124.

As the foregoing description, the light guide component 123 includes an incident surface 126 (as shown in FIG. 2A and FIG. 2B), and the incident surface 126 includes at least one V-shape groove 128 (as shown in FIG. 2A and FIG. 2B). The V-shape grooves 128 are used for guiding the incident light 140 such that an incident angle of light entering into the incident surface 126 is increased, and therefore the destiny of light in the transparent panel 110 is raised.

The retro-reflectors 130 are disposed on the sides 115 of the transparent panel 110 to reflect the incident light 140 and adhered by a second optical clear adhesive 131 located between the sides 115 and the retro-reflectors 130. The optical sensor 125 is used for receiving the incident light 140 reflected by the retro-reflector 130. The light source 122 and the optical sensor 125 are disposed on a substrate 121. The substrate 121 disposed on the bottom surface 112 is a flexible printed circuit (FPC). The light source 122 and the optical sensor 125 are set by properly arranging the substrate 121, in which the light source 122 and the optical sensor 125 are disposed on the bottom surface 112. In addition, both a vertical distance between the light source 122 and the touch surface 111 and a vertical distance between the optical sensor 125 and the touch surface 111 are greater than the vertical distance between the bottom surface 112 and the touch surface 111.

The incident angle of the incident light 140 emitted by the light source 122 can be adjusted by the light guide component 123, such that the incident light 140 enters into the transparent panel 110 with a greater angle, and therefore a number of total reflection times of the incident light 140 between the touch surface 111 and the bottom surface 112 can be increased. The incident light 140 travels forward in the transparent panel 110 in the way of total reflection between the touch surface 111 and the bottom surface 112 until the incident light 140 reaches the retro-reflectors 130. After the incident light 140 is reflected by the retro-reflectors 130, the incident light 140 goes in the reversed original path, and then the optical sensor 125 captures the incident light 140. Due to the fact that incident light 140 is totally reflected between the touch surface 111 and the bottom surface 112, there is almost no decrease in the intensity of the incident light 140.

In the present embodiment, the optical sensor 125 is disposed between the light source 122 and the bottom surface 112. However, in some embodiments of the present invention, the light source 122 is disposed between the optical sensor 125 and the bottom surface 112, or the light source 122 and the optical sensor 125 are disposed at the same height level. Above relative locations about the light source 122 and the optical sensor 125 would not affect the detection result of the optical touch screen 100.

Even though the structure of the camera modules 120a and 120b are different with the first embodiment, the principle how the optical touch screen 100 detects the locations touched by the users with the light is the same. However, in the present embodiment, the corners of the transparent panel 110 need not be cut into the bevel structure, such that the manufacture is more efficient.

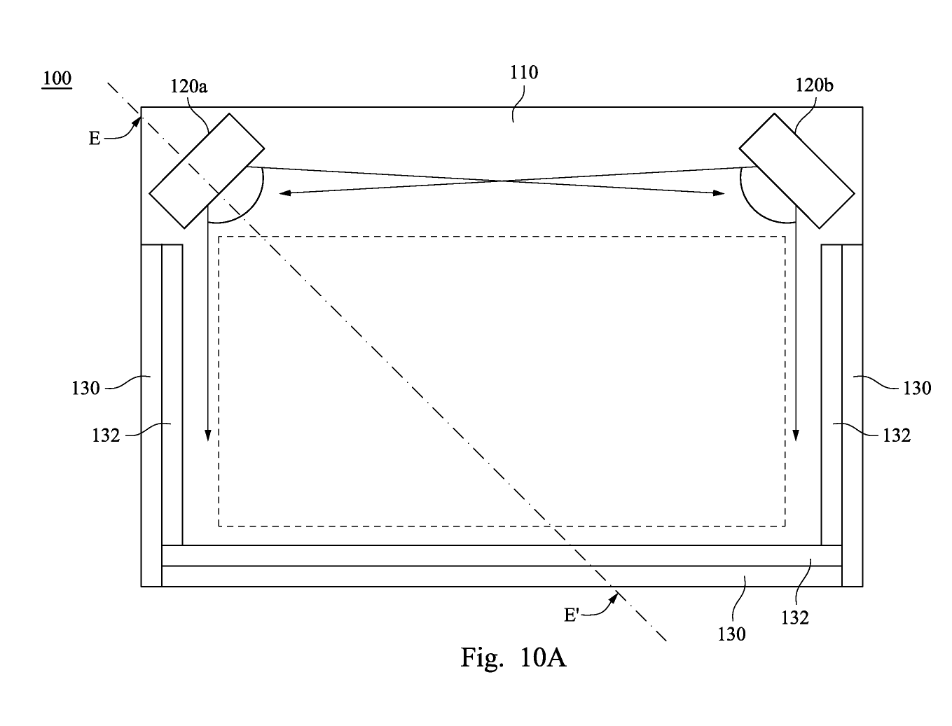

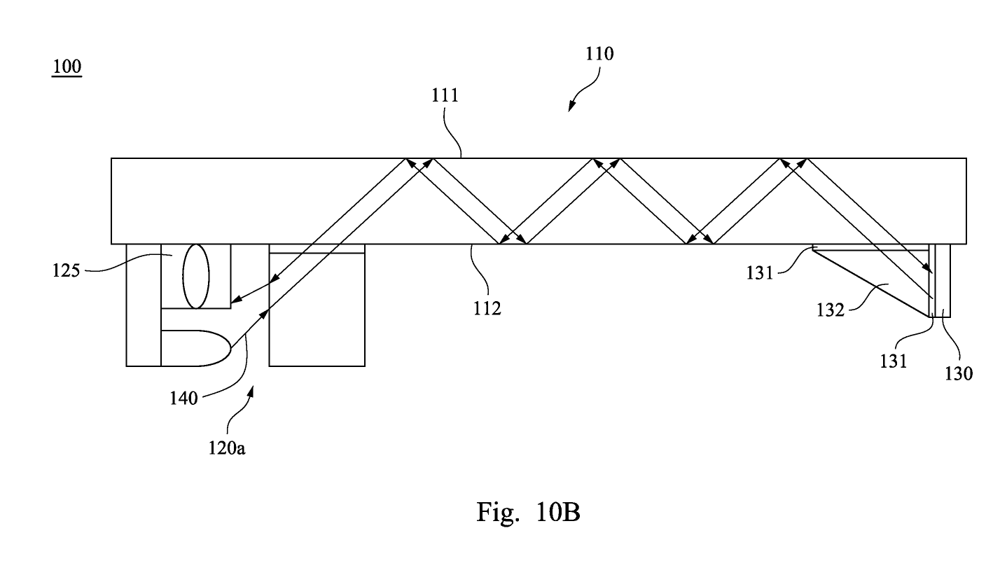

FIG. 10A is a bottom view of an optical touch screen according to a fifth embodiment of the present invention. FIG. 10B is a cross-sectional view in FIG. 10A taken along line E-E′. An optical touch screen 100 includes a transparent panel 110, camera modules 120a and 120b, and at least one retro-reflector 130, in which the arrangement and the function of transparent panel 110 and camera modules 120a and 120b are the same as the fourth embodiment.

The retro-reflectors 130 stand on a bottom surface 112 of the transparent panel 110, and the optical touch screen 100 further includes a triangular prism 132 used for guiding the incident light 140 to the retro-reflectors 130. Two sides of the triangular prism 132 are connected to the retro-reflectors 130 and the bottom surface 112 through the second optical clear adhesive 131 respectively. According to an embodiment of the present invention, a refractive index of the triangular prism 132, the second optical clear adhesive 131 and the transparent panel 110 are approximately the same, such that an optical error caused by the medium characteristic changing and a possibility of the reflection and the refraction occurring at an interface of the light are reduced. Furthermore, a vertical distance between the retro-reflectors 130 and a touch surface 111 is greater than a vertical distance between the bottom surface 112 and the touch surface 111.

After the incident light 140 enters into the transparent panel 110, the incident light 140 travels forward in the way of total reflection between the touch surface 111 and the bottom surface 112. Then, after the incident light 140 enters into the triangular prism 132 and is guided to the retro-reflectors 130 via the second optical clear adhesive 131, the incident light 140 goes in the reversed original path, and then the optical sensor 125 captures the incident light 140.

In the present embodiment, the retro-reflectors 130 are disposed at different positions with the fourth embodiment, and therefore a thickness of the transparent panel 110 of the present embodiment is thinner than the fourth embodiment.

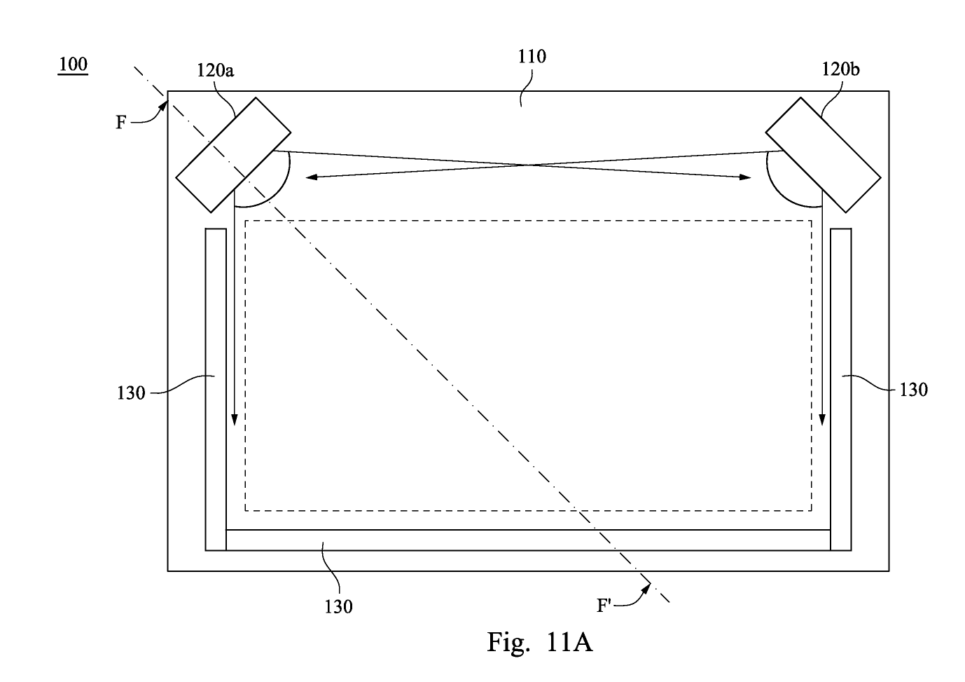

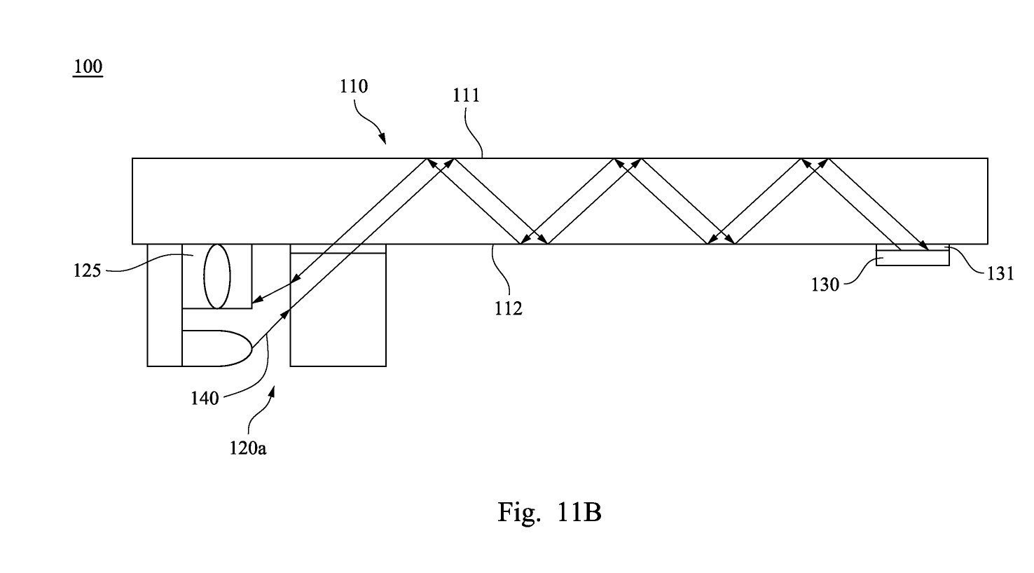

FIG. 11A is a bottom view of an optical touch screen according to a sixth embodiment of the present invention. FIG. 11B is a cross-sectional view in FIG. 11A taken along line F-F′. An optical touch screen 100 includes a transparent panel 110, camera modules 120a and 120b, and at least one retro-reflector 130, in which the arrangement and the function of transparent panel 110 and camera modules 120a and 120b are the same as in the fourth embodiment.

The retro-reflectors 130 for reflecting an incident light 140 are disposed and laid on the bottom surface 112 of the transparent panel 110, the retro-reflectors 130 are fastened on the transparent panel 110 by a second optical clear adhesive 131.

After the incident light 140 enters into the transparent panel 110, the incident light 140 travels forward in the way of total reflection between the touch surface 111 and the bottom surface 112. Then, incident light 140 passes through the second optical clear adhesive 131 and is reflected by the retro-reflectors 130. The incident light 140 goes in the reversed original path, and then an optical sensor 125 captures the incident light 140.

In the present embodiment, through an arrangement the retro-reflectors 130 are laid on the bottom surface 112, the thickness of the transparent panel 110 is reduced. Moreover, since the arrangement that the retro-reflectors 130 are laid on the bottom surface 112 is different with the standing arrangement of the fifth embodiment, a thickness and a volume of the optical touch screen 100 becomes thinner and smaller.

By using the well-designed camera modules, after the incident light enters into the transparent panel, the incident light travels forward with the way of total reflection between the touch surface and the bottom surface. When the user touches the transparent panel, the total reflection may be destroyed, and the intensity of the incident light may decrease. Therefore, a light signal from a specific direction received by the optical sensor may be weaken, so the position where the finger touches the transparent panel can be known.

According to the above embodiments, the light guide component of the camera module of the present invention can make the incident light enter into the transparent panel with a greater incident angle, and therefore the light density of the transparent panel is raised when the number of the effective light is increased. Hence, the thickness and the volume of the optical touch screen of the present invention become thinner and smaller.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical touch screen, comprising:
a transparent panel comprising a bottom surface and a touch surface opposite to each other, a corner and a plurality of sides;
a camera module disposed on the corner, comprising:
a light source for emitting an incident light, wherein a vertical distance between the light source and the touch surface is greater than a vertical distance between the bottom surface and the touch surface;
a light guide component;
an optical clear adhesive fixing the light guide component on the transparent panel, wherein the incident light enters the transparent panel through the light guide component and the optical clear with total reflection between the bottom surface and the touch surface; and
an optical sensor for receiving light signal; and
at least one retro-reflector for reflecting the incident light, the incident light traveling with reversed and parallel to original direction after the reflection is received by the optical sensor, wherein a refractive index of the light guide component, the optical clear adhesive and the transparent panel are approximately the same.

2. The optical touch screen of claim 1, wherein the light guide component comprises a protrusion protruding toward the bottom surface, and a gap between the light guide component and the bottom surface is partially filled with the optical clear adhesive.

3. The optical touch screen of claim 2, wherein the retro-reflectors are disposed on the sides of the transparent panel.

4. The optical touch screen of claim 2, wherein the retro-reflectors are disposed and laid on the bottom surface of the transparent panel.

5. The optical touch screen of claim 2, wherein the retro-reflectors stand on the bottom surface of the transparent panel, and the optical touch screen further comprises a triangular prism with two sides connecting the retro-reflectors and the bottom surface respectively.

6. The optical touch screen of claim 5, wherein a refractive index of the triangular prism and the refractive index of the transparent panel are the same.

7. The optical touch screen of claim 1, wherein the sides of the transparent panel are orthogonal at the corner, the light source and the optical sensor are disposed on the bottom surface with both the vertical distance between the light source and the touch surface and a vertical distance between the optical sensor and the touch surface are greater than the vertical distance between the bottom surface and the touch surface.

8. The optical touch screen of claim 7, wherein the vertical distance between the light source and the touch surface and the vertical distance between the optical sensor and the touch surface are the same.

9. The optical touch screen of claim 7, wherein a gap between the light guide component and the bottom surface is totally filled with the optical clear adhesive.

10. The optical touch screen of claim 7, wherein the retro-reflectors are disposed on the sides of the transparent panel.

11. The optical touch screen of claim 7, wherein the retro-reflectors are disposed and laid on the bottom surface of the transparent panel.

12. The optical touch screen of claim 7, wherein the retro-reflectors stand on the bottom surface of the transparent panel, and the optical touch screen further comprises a triangular prism with two sides connecting the retro-reflectors and the bottom surface respectively.

13. The optical touch screen of claim 12, wherein a refractive index of the triangular prism and the refractive index of the transparent panel are the same.

14. The optical touch screen of claim 1, wherein the light guide component comprises an incident surface with at least one V-shape groove.

15. The optical touch screen of claim 1, wherein the corner comprises a bevel structure to provide a guide surface connecting the adjacent sides.

16. The optical touch screen of claim 15, wherein an angle between the guide surface and the adjacent side is about 45 degrees.

17. The optical touch screen of claim 1, wherein the camera module comprises a substrate, and the light source and the optical sensor are disposed on the substrate.

18. The optical touch screen of claim 1, wherein structure of the retro-reflectors is thin layer.

19. The optical touch screen of claim 1, wherein the transparent panel is made of glass, low-iron glass, or poly(methyl methacrylate) (PMMA).

20. The optical touch screen of claim 1, wherein the light source is an Infrared light-emitting diode (IR LED).
